(19) United States
(12) Patent Application Publication
(10) Pub. No.: US 2013/0216646 A1
(43) Pub. Date: Aug. 22, 2013

(54) Nanoparticles of Nutritional and Pharmaceutical Compounds

(71) Applicants: Kandalam V. Ramanujachary, Glassboro, NJ (US); Amos Mugweru, Glassboro, NJ (US); Christopher Kelbon, Turnersville, NJ (US)

(72) Inventors: Kandalam V. Ramanujachary, Glassboro, NJ (US); Amos Mugweru, Glassboro, NJ (US); Christopher Kelbon, Turnersville, NJ (US)

(21) Appl. No.: 13/444,826

(22) Filed: Apr. 11, 2012

Related U.S. Application Data
(60) Provisional application No. 61/474,178, filed on Apr. 11, 2011.

(51) Int. Cl. A23L 1/304

(52) U.S. Cl. CPC A23L 1/3045
USPC 426/2; 428/402; 426/648; 204/157.9; 562/582

(57) ABSTRACT

The invention relates to a composition in particle form having the structure:

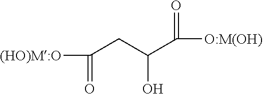

wherein M and M′ are each independently a nutritionally relevant divalent metal and the particles are of a size between 1 micron and 1 nanometer. M and M′ may be the same or different nutritionally relevant divalent metal selected from the group consisting of copper, zinc, manganese, iron, magnesium, and calcium. The particles may be made according to a process that includes application of microwave hydrothermal energy and/or ultrasonification.

### CROSS REFERENCE TO RELATED APPLICATIONS

This application claims priority from provisional patent application No. 61/474,178, filed Apr. 11, 2011, the entirety of which is incorporated herein by reference.

### FIELD OF THE INVENTION

The present invention is directed to methods of making nanosized active ingredients, their use in compositions, and methods of making and administering the compositions with nanosized active ingredients. The nanosized active ingredients can be used for pharmaceutical, nutritional and mineral supplementation. One specific nanosized active ingredient disclosed herein is dicalcium malate, also known as dihydroxycalcium malate.

### BACKGROUND OF THE INVENTION

Calcium is the most abundant mineral in the human body. Of the calcium contained in the average body, about 99% is located in the bones, including the teeth. Calcium is necessary for a number of purposes: forming bones and teeth, blood clotting, transmission of signals in nerve cells, and muscle contraction. Calcium supplementation is believed to reduce the incidence of osteoporosis. However, the form or source of calcium for supplementation has been a source of confusion in the industry. Calcium carbonate is one form of calcium that is widely used, although it is not believed to be absorbed as well as some other forms of calcium. Calcium citrate provides a form that is believed to be better absorbed than calcium carbonate. Calcium citrate/malate (CCM) is believed to be absorbed more fully than calcium carbonate as well.

Other divalent minerals, such as magnesium, zinc, copper, iron, and manganese, are known to be important to the human diet, and can be administered in a supplemental form. Magnesium is needed for bone, protein, and fatty acid formation as well as for the formation of new cells, activating certain vitamins, relaxing muscles, clotting blood, and forming ATP. It also has been reported that people with diabetes often have magnesium levels that are lower than normal compared to those having normal glucose tolerance. Zinc is known to be involved in the transport of vitamin A, taste, wound healing, and fetal development. Zinc also plays a role in the correct functioning of many enzymes, hormones including insulin, genetic material, and proteins. Copper plays a role in the absorption of iron, and is part of many enzymes. Iron is necessary for production of hemoglobin and oxygenation of red blood cells, building up blood quality, and increasing resistance as well as increasing energy production. Manganese improves memory and reflexes, reduces fatigue, and promotes proper development of thyroid hormones, skeletal, reproductive, and central nervous systems.

The chemical symbols for these minerals are as follows:

### Calcium: Ca; Zinc: Zn; Iron: Fe; Magnesium: Mg; Copper: Cu; Manganese: Mn

Malic acid is a naturally occurring dicarboxylic acid that is found in a wide variety of fruits (including richly in apples) and vegetables. Malic acid plays a role in the complex process of deriving ATP (the energy currency that runs the body) from food. As malic acid is already found abundantly in humans and other warm-blooded animals, it can be administered at therapeutic levels without adverse affects. Further, there is some evidence that malic acid supplementation can be helpful to human nutrition.

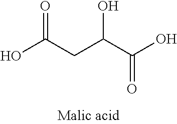

One suitable form of the divalent minerals listed above are described in U.S. Pat. No. 6,706,904, the contents of which are incorporated herein in its entirety by reference for its disclosure of synthesis and use of divalent complexes, as well as their administration to treat conditions in humans and animals. The divalent complexes are used to provide a quantity of a bioavailable form of certain nutritionally relevant metals and have the following structure:

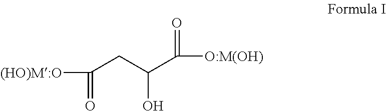

In the above formula, M and M′ are each independently a nutritionally relevant divalent metal. M and M′ may be the same or different. The '904 patent discloses a method of making a the divalent metal-containing complex above by reacting malic acid with a divalent metal-containing composition at a 1:2 molar ratio. The disclosure of the '904 patent is incorporated herein also for its disclosure of these processes.

Calcium is absorbed as the divalent cation. Most dietary calcium is not ionic, and is insoluble at a neutral pH. Gastric acid solubilizes Ca²⁺ salts and allows their absorption from the intestine. Calcium is absorbed from the duodenum and upper jejunum primarily by an active vitamin D-dependent transcellular process; in the ileum, the predominant process is passive vitamin D-independent, paracellular diffusion. Absorption of Ca²⁺ in the ileum is about one-third as rapid in the upper small intestine. Although the duodenum is the region of most efficient calcium absorption, the greatest proportion of calcium is probably absorbed in the ileum, especially under conditions when transcellular transport is decreased, as in old age. The improved efficiency of absorption in the duodenum may be a result of the gastric hydrochloric acid that helps calcium absorption, while in contrast the efficiency may be reduced farther down the small intestine where the local environment becomes more alkaline. The gastrointestinal tract of a human is illustrated in FIG. 1.

An important consideration in designing a delivery system for calcium is the relative contribution of the different segments of the intestinal tract to overall calcium absorption, with the small intestine accounting for about 90%. Despite the vigor of the active transport process by the duodenum, most of the absorption of ingested calcium occurs in the lower segment of the small intestine, the ileum. In one study it was shown that in the rat small intestine, 88% of calcium absorption in this segment occurs in the ileum, 4% in the jejunum, and 8% in the duodenum. In another study it was shown that 65, 17, and 7% of the absorption of calcium in the rat intestine occurs in the ileum, jejunum, and duodenum, respectively. It has been reported that in dogs, the respective values in the ileum, jejunum, and duodenum are 80, 16, and 4%. An important factor determining the contribution of the ileum to overall calcium absorption is the relatively long transit time of calcium in that segment relative to the other segments of the small intestine. The transit half-time in rat ileum has been reported to be 102 min and in the duodenum, 6 min; another study estimated that sojourn times in rat ileum and duodenum are 121.5 and 2.2 min, respectively.

### SUMMARY OF THE INVENTION

In one general aspect there is provided a composition in particle form having the structure:

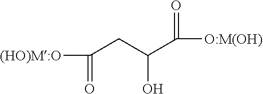

wherein M and M′ are each independently a nutritionally relevant divalent metal and the particles are of a size between 1 micron and 1 nanometer.

Embodiments of the invention may include one or more of the following features. For example, in the composition M is one or more of calcium, magnesium, zinc, copper, iron, manganese. M and M′ may be the same nutritionally relevant divalent metal selected from the group consisting of copper, zinc, manganese, iron, magnesium, and calcium. In another embodiment, M and M′ are different nutritionally relevant divalent metals, each being selected from the group consisting of copper, zinc, manganese, iron, magnesium, and calcium.

The particles may be made according to a process that includes application of microwave hydrothermal energy. The application of microwave energy under hydrothermal conditions may occur during synthesis of the compound. The product resulting from the synthesis may be subjected to ultrasonification to reduce the particle size. In another embodiment, the particles are made according to a process that includes ultrasonification.

In another general aspect, there is provided a method of improving the nutritional status of a warm-blooded animal by administering a composition that includes a compound of the structure:

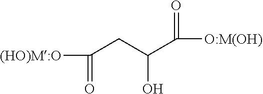

wherein M and M′ are each independently a nutritionally relevant divalent metal and the particles of the compound used in the composition were or are of a size between 1 micron and 1 nanometer.

Embodiments of the method may include one or more of the following features. For example, M and M′ may be the same nutritionally relevant divalent metal selected from the group consisting of copper, zinc, manganese, iron, magnesium, and calcium. In another embodiment, M and M′ may be different nutritionally relevant divalent metals, each being selected from the group consisting of copper, zinc, manganese, iron, magnesium, and calcium. The method may further include the preliminary step of formulating the composition into a tablet or capsule for oral delivery or into a food or beverage for oral delivery.

In another general aspect there is provided a process for making a bioavailable divalent metal-containing complex in nanosized particle form of the following formula

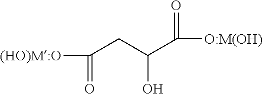

In which the method includes the steps of

adding malic acid and one or more divalent metal-containing compositions to a reaction vessel, wherein M and M′ are each independently a nutritionally relevant divalent metal selected from calcium, magnesium, zinc, copper, iron, and manganese;

reacting the malic acid with the one or more divalent metal-containing composition; and

applying microwave hydrothermal energy to the reaction vessel and contents, wherein the resulting particles have a size between one micrometer and one nanometer.

Embodiments of the process may include one or more of the following features. For example, M and M′ may be the same or different nutritionally relevant divalent metals selected from the group consisting of copper, zinc, manganese, iron, magnesium, and calcium.

The process may further include the step of applying ultrasonification to the particles to reduce the particle size. The nanosized particles may be formulated into a formulation, such as a tablet, capsule, food or beverage.

In another general aspect, there is provided a process of making a bioavailable divalent metal-containing complex in nanosized particle form of the following formula

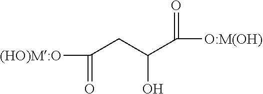

the method comprising:

adding malic acid and one or more divalent metal-containing compositions to a reaction vessel, wherein M and M′ are each independently a nutritionally relevant divalent metal selected from calcium, magnesium, zinc, copper, iron, and manganese;

reacting the malic acid with the one or more divalent metal-containing composition; and

applying ultrasonification to the resulting composition, wherein the resulting particles have a size between one micrometer and one nanometer.

Embodiments of the process may include one or more of the following features. For example, M and M′ may be the same or different nutritionally relevant divalent metals, each being selected from the group consisting of copper, zinc, manganese, iron, magnesium, and calcium. The nanosized particles may be formulated into a formulation, such as a tablet, capsule, food or beverage.

### BRIEF DESCRIPTION OF THE DRAWINGS

FIG. 1 is an illustration of the gastrointestinal tract of a human.

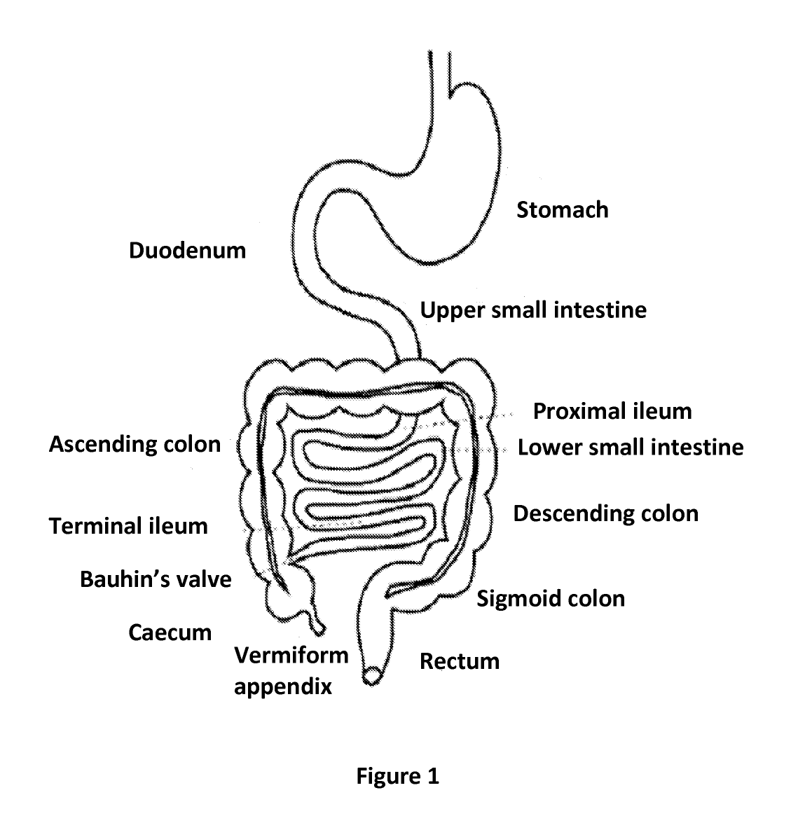

FIG. 2 is a scanning electron micrograph of regularly sized particles of dihydroxycalcium malate.

FIG. 3 is a scanning electron micrograph of nanosized particles of dihydroxycalcium malate.

, FIG. 4 is a graph showing the dissolution of regularly sized and nanosized particles of dihydroxycalcium malate with the conductivity of the solution measured over time.

FIG. 5 is an infrared spectra of calcium succinate without titanate.

FIG. 6 is an infrared spectra of titanium oxide.

FIG. 7 is an infrared spectra of calcium succinate with titanate.

FIG. 8 is a graph of the TGA results for calcium succinate.

FIG. 9 is a graph of the TGA results for calcium succinate with titanate.

FIG. 10 is a Proton NMR graph showing the succinate structure.

FIG. 11 is an XRD pattern for titanium oxide.

FIG. 12 is an XRD pattern for calcium succinate.

FIG. 13 is an XRD pattern of calcium succinate with titanium oxide.

### DETAILED DESCRIPTION OF THE PREFERRED EMBODIMENT(S)

The term “nutritionally relevant metal” or “nutritionally relevant divalent metal” means any divalent metal that can be used as part of a nutritional supplement, is known to be beneficial to humans and other warm-blooded animals, and is substantially non-toxic when administered in traditional amounts, as is known in the art. Examples of such metals include copper, zinc, manganese, iron, magnesium, calcium, and the like.

When referring to a dimetalhydroxy malate (such as dicalciumhydroxy malate, dimagnesium malate, etc.), the “di” portion of the name refers to two ⁺M(OH) or metalhydroxy groups, one being complexed to a first carboxyl group of the malate ion, and the other being complexed to a second carboxyl group of the malate ion. Thus, each metal is complexed to the malate ion and is also complexed to its own hydroxy group to charge balance the metal. The metals that can be used include divalent nutritionally relevant metals, and two of the same metal or two different metals can be present at each carboxyl group of the malate ion.

The term “divalent metal-containing composition” shall mean compositions used to react with malic acid to form a dimetalhydroxy malate in accordance with embodiments of the present invention, wherein the metal can be two of the same metal, or two different metals. Elemental divalent metals, divalent metal hydroxides, divalent metal oxides, and divalent metal carbonates are included.

In one embodiment of the present invention, there is provided a composition in nanosized form having the structure of Formula I in which M and M′ are each independently a nutritionally relevant divalent metal.

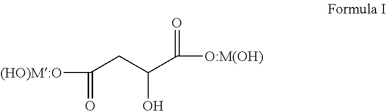

In Formula I, M and M′ can be the same divalent metal, or can be different divalent metals. Though any nutritionally relevant divalent metal can be used, calcium, magnesium, copper, zinc, manganese, and iron provide examples of desired metals for use.

The composition of nanosized Formula I above can be administered to the warm-blooded animal, such as a human. The administration can be by one of many known administration routes, including oral administration. If formulated for oral delivery or consumption, such a composition can be incorporated into many delivery vehicles, including tablets, capsules, foods, drinks, dry drink mixes, or other substances acceptable for oral consumption. Tablets may be chewable or non-chewable. A food delivery vehicle may be, for example, in the form of food bars or incorporated into dairy products. Drinks may be in the form of sports drinks, fruit drinks, citrus drinks, carbonated drinks, and other suitable drink mediums. Dry drink mixes may be in the form of a fruit mix and/or citrus mix or other particulate drink mixes.

No matter what the vehicle of delivery, the compositions of the present nanosized invention are very stable, and thus, can be coadministered with many other supplements known in the art. For example, the compositions of the present invention can be coadministered with mineral salts and/or mineral amino acid chelates in drink mixes, supplement tablets or capsules, or food items.

In another embodiment, a method of making a nanosized bioavailable divalent metal-containing complex involves the step of reacting malic acid with one or more divalent metal-containing compositions at a 1:2 molar ratio. In the process the divalent metal of the composition is a nutritionally relevant divalent metal and the process is conducted under microwave hydrothermal conditions. This can be done in the presence of excess water, or can be done by providing a particulate blend of the malic acid and the divalent metal-containing composition, and then adding small amounts of water stepwise. The process occurs while applying microwave energy to the system. The nanosized bioavailable divalent metal-containing complex formed has the structure of Formula I above.

Alternatively, the divalent metal-containing complex can be formed in the presence or absence of the application of microwave hydrothermal energy. For example, the resulting divalent metal-containing complex can be formed and then subjected to particle size reduction using ultrasonification. Alternatively, the divalent metal-containing complex can be formed using microwave hydrothermal energy such that the particles of the complex are micro- or nanosized and then subjected to further particle sized reduction by ultrasonification. Alternatively, the divalent metal-containing complex can be formed using the methods disclosed in U.S. Pat. No. 6,706,904. The resulting product is not of nanosized proportion but can have the particle size reduced to nanosized proportion by application of ultrasonification to the divalent metal-containing composition.

There are at least five general specific reaction schemes that can be followed in carrying out the method of making the nanosized compounds of Formula I, though these reaction schemes are not intended to be limiting. In these reactions, M is any nutritionally relevant divalent metal including iron, magnesium, calcium, manganese, zinc, or copper.

A first reaction scheme is depicted below in which two extra water molecules are formed as the hydrogen atoms are liberated from the malic acid and react with the excess hydroxy groups from the two metal hydroxides. The process occurs while applying microwave energy to the system. The resulting product is of nanosized proportions. Alternatively, the process occurs according to the disclosure of U.S. Pat. No. 6,706,904 in which the resulting particles are not of nanosized proportions. The resulting particles then are subjected to particle size reduction using ultrasonification. M is any nutritionally relevant divalent metal and the two metals may be the same or different:

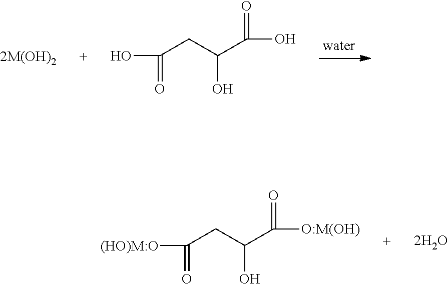

A second reaction scheme is depicted below. In the second reaction scheme, when a metal oxide is used, no extra water molecules are formed. The process occurs while applying microwave energy to the system. The resulting product is of nanosized proportions. Alternatively, the process occurs according to the disclosure of U.S. Pat. No. 6,706,904 in which the resulting particles are not of nanosized proportions. The resulting particles then are subjected to particle size reduction using ultrasonification. M is any nutritionally relevant divalent metal and the two metals may be the same or different:

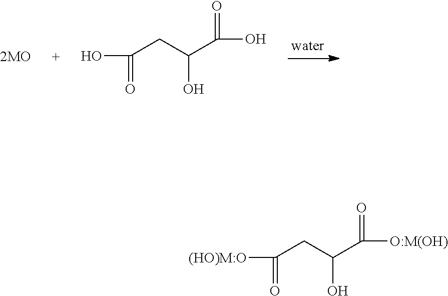

A third reaction scheme is depicted below. In the third reaction scheme, when an elemental metal is used, the extra oxygen atoms that are present in the resulting product come from the water, and two hydrogen atoms remain, either to remain in ionic form in the water, or to form H₂ gas. The process occurs while applying microwave energy to the system. The resulting product is of nanosized proportions. Alternatively, the process occurs according to the disclosure of U.S. Pat. No. 6,706,904 in which the resulting particles are not of nanosized proportions. The resulting particles then are subjected to particle size reduction using ultrasonification. M is any nutritionally relevant divalent metal and the two metals may be the same or different:

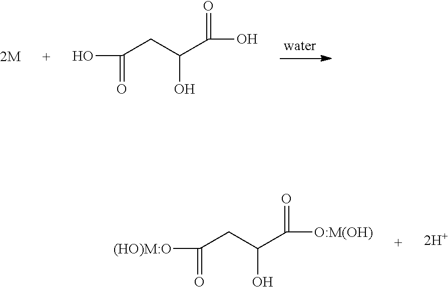

A fourth reaction scheme is depicted below. In the fourth reaction scheme, when a metal carbonate is used, two carbon dioxide molecules are formed. The process occurs while applying microwave energy to the system. The resulting product is of nanosized proportions. Alternatively, the process occurs according to the disclosure of U.S. Pat. No. 6,706,904 in which the resulting particles are not of nanosized proportions. The resulting particles then are subjected to particle size reduction using ultrasonification. M is any nutritionally relevant divalent metal and the two metals may be the same or different:

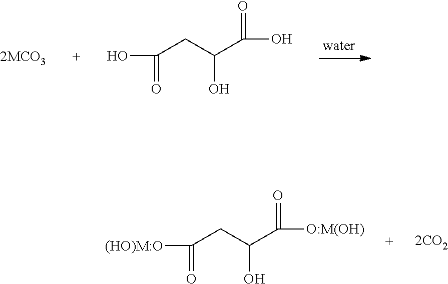

As a fifth reaction, the source of the metal may be calcium nitrate. The process occurs while applying microwave energy to the system. The resulting product is of nanosized proportions. Alternatively, the process occurs according to the disclosure of U.S. Pat. No. 6,706,904 in which the resulting particles are not of nanosized proportions. The resulting particles then are subjected to particle size reduction using ultrasonification. M is any nutritionally relevant divalent metal and the two metals may be the same or different. In the product, M is calcium:

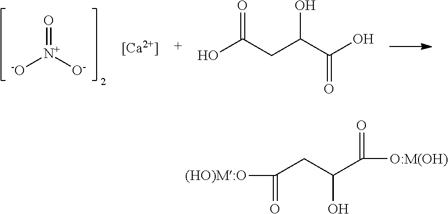

Although each of the five reaction schemes illustrated above show only a single metal (M) being used in the reaction, combinations of any two metals can also be present on a single malate ion. In other words, by modifying the reaction schemes to include two different compositions of metal oxides, hydroxides, carbonates, nitrate, or elemental metals, such compositions can be formed as would be apparent to one skilled in the art after considering the present disclosure. For example, in one embodiment, rather than using two molar equivalents of calcium hydroxide in the first reaction scheme, one can use one molar equivalent of calcium hydroxide and one molar equivalent of iron hydroxide to obtain such a result. If such a composition were prepared, three possible compositions could be present in the preparation, including 1) dicalciumhydroxy malate, 2) di-ironhydroxy malate, and 3) calciumhydroxy ironhydroxy malate. Examples of the preparation of compositions having one type of metal at both carboxyl groups of the malate ion, or two different metals at each carboxyl group of the malate ion will be provided below.

With respect to each of the compositions and methods of the present invention, once formed in an aqueous solution with application of microwave hydrothermal energy, the product can be dried to give nanosized particles of the dihydroxy malate compound. If not formed with application of microwave hydrothermal energy, the resulting product can be subjected to ultrasonification for particle size reduction. If the product is formed with application of microwave hydrothermal energy, the resulting product may be of nanosized or microsized proportions and then subjected to additional particle size reduction using ultrasonification.

In one embodiment, in which the process is carried out without microwave hydrothermal energy, the process is carried out by first, combining the reactants, i.e., malic acid and divalent metal-containing composition, in dry form and mixing them together, such as in a Ribbon Blender or the like. The mixing device can be continuously run during this process for acceptable results. A fraction of the total amount of water needed to effectuate the reaction can then be slowly added, such as by spraying the water into the particulate mixture. The water is preferably sprayed, as dumping water onto the reactants tends to cause over reaction and clumping. In one embodiment, from 5% to 20% of the water necessary to complete the reaction can be added or sprayed on at a time, allowing reaction time to occur between each further water addition. A water jacket can be used with the reaction vessel to keep the reactants cool.

As the water is added in small amounts stepwise, the product will progress toward completion. At each stage of added water, the reactants tend to become sponge-like and raise in level within the mixer. When the reaction nears completion for a given stage, the heat lowers, the product level falls, and the density increases, returning the product to a more granular state. Next, more water is added, and a similar phenomenon reoccurs (typically to a lesser extent at each water addition step). At each stage, the product should be allowed to react until the reaction is substantially complete. Once the heat and expansion is substantially absent when water is added, the process is complete. At this point, if water is continued to be added, the product will begin to change back to a powder form, which is undesirable. Therefore, care should be taken to stop adding water when desired granulation is present, and the reaction has substantially stopped. Upon completion of the process, the product can be removed from the mixing device, placed in an ultrasonification device and subjected to particle size reduction.

### EXAMPLES

The following examples illustrate embodiments of the invention. A representative number of compositions and their methods of manufacture are disclosed herein. The methods may be partially or completely hypothetical or actual.

### Example 1

An aqueous solution of malic acid is prepared by mixing 14.79 g of malic acid with 25 mL of water until the solution is clear. An aqueous solution of calcium hydroxide is also prepared in a separate container by thoroughly mixing 16.34 g of calcium hydroxide in 25 mL of water. The calcium hydroxide solution is then added to the malic acid solution in a reaction vessel while applying microwave hydrothermal energy to the reaction solution. The resulting product is a dicalciumhydroxy malate-containing solution having a slight yellow color. Upon drying the particles in the solution, the dicalciumhydroxy malate is of nanosized proportion.

### Example 2

An aqueous solution of malic acid is prepared by mixing 134.09 g of malic acid with 25 mL of water until the solution is clear. Next, 112.18 g of particulate calcium oxide is slowly added to the aqueous mixture while stirring. The aqueous mixture is stirred for 45 minutes and then spray dried. The resulting product is a dicalciumhydroxy malate powder. The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of calcium oxide and aqueous malic acid, the aqueous mixture is subjected to microwave hydrothermal energy. The resulting product is nanosized particles of dicalciumhydroxy malate powder.

### Example 3

A large batch of dicalciumhydroxy malate is produced by mixing 19.16 kg of malic acid in 68.19 L of water. In a separate tank, 16.33 kg of calcium oxide is mixed in 68.19 L of water. The two solutions are slowly mixed together and stirred. A milky solution containing the product results, which is spray dried to obtain a powdered product of dicalciumhydroxy malate. The resulting product then is placed in a ultrasonification device. On placing the particles in an ultrasonification device and applying ultrasonification energy, the size of the particles are reduced to nanosized proportions.

As a modification to the process, rather than spray drying, upon forming the aqueous mixture of calcium oxide and aqueous malic acid, the aqueous mixture is subjected to microwave hydrothermal energy. The resulting product is nanosized particles of dicalciumhydroxy malate powder.

### Example 4

An aqueous solution of malic acid is prepared by mixing 134.09 g of malic acid with 50 mL of water. An aqueous solution of calcium carbonate is also prepared in a separate container by thoroughly mixing 200.18 g of calcium carbonate in 50 mL of water. The calcium carbonate solution is then slowly added to the malic acid solution. The resulting solution is spray dried to produce a powdered dicalciumhydroxy malate. The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of calcium carbonate and aqueous malic acid, the aqueous mixture is subjected to microwave hydrothermal energy. The resulting product is nanosized particles of dicalciumhydroxy malate powder.

### Example 5

An aqueous solution of malic acid is prepared by mixing 5.859 kg of malic acid with 18.18 L of water until the solution is clear. An aqueous solution of magnesium oxide is also prepared in a separate container by thoroughly mixing 3.515 kg of magnesium oxide in 18.18 L of water. The magnesium oxide solution is then slowly added to the malic acid solution. The resulting solution is cooled, and then spray dried to produce a powdered dimagnesiumhydroxy malate. The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of magnesium oxide and aqueous malic acid, the aqueous mixture is subjected to microwave hydrothermal energy. The resulting product is nanosized particles of dimagnesiumhydroxy malate powder.

### Example 6

An aqueous solution of malic acid is prepared by mixing 134.09 g of malic acid with 50 mL of water. An aqueous solution of copper(II)hydroxide is also prepared in a separate container by thoroughly mixing 195.12 g of copper(II)hydroxide in 50 mL of water. The copper(II)hydroxide solution is then slowly added to the malic acid solution. The resulting solution is spray dried to produce a powdered dicopper(II)hydroxy malate. The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of copper(II)hydroxide and aqueous malic acid, the aqueous mixture is subjected to microwave hydrothermal energy. The resulting product is nanosized particles of dicopperhydroxy malate powder.

### Example 7

An aqueous solution of malic acid is prepared by mixing 134.09 g of malic acid with 50 mL of water. An aqueous solution of zinc oxide is also prepared in a separate container by thoroughly mixing 162.78 g of zinc oxide in 50 mL of water. The zinc oxide solution is then slowly added to the malic acid solution. The resulting solution is spray dried to produce a powdered dizinchydroxy malate. The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of zinc oxide and aqueous malic acid, the aqueous mixture is subjected to microwave hydrothermal energy. The resulting product is nanosized particles of dizinchydroxy malate powder.

### Example 8

An aqueous solution of malic acid is prepared by mixing 134.09 g of malic acid with 50 mL of water. Next, 111.69 g of ferronyl powder is added to the malic acid solution. The solution is stirred for approximately 2 hours. The resulting solution is then spray dried to produce a powdered dihydroxyferrous malate. The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of ferrous hydroxide and aqueous malic acid, the aqueous mixture is subjected to microwave hydrothermal energy. The resulting product is nanosized particles of diferroushydroxy malate powder.

### Example 9

An aqueous solution of malic acid is prepared by mixing 134.09 g of malic acid with 50 mL of water. Next, 109.88 g of Mn metal is added slowly to the malic acid solution. The solution is stirred for approximately 2 hours. The resulting solution is then spray dried to produce a powdered dimanganesehydroxy malate. The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of manganese and aqueous malic acid, the aqueous mixture is subjected to microwave hydrothermal energy. The resulting product is nanosized particles of dimanganesehydroxy malate powder.

### Example 10

An aqueous solution of malic acid is prepared by mixing 134.09 g of malic acid with 50 mL of water. An aqueous solution of zinc oxide is also prepared in a separate container by thoroughly mixing 81.39 g of zinc oxide in 50 mL of water. Next, 54.94 g of ferronyl powder is then added to the malic acid solution. The zinc oxide solution is then slowly added to the iron/malic acid solution. The solution is allowed to mix for approximately 2 hours. The resulting solution is then spray dried to produce a powdered dihydroxyzinc ferrous malate (or zinc hydroxy ferrous hydroxy malate). The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of zinc oxide, iron and aqueous malic acid, the aqueous mixture is subjected to microwave hydrothermal energy. The resulting product is nanosized particles of dihydroxyzinc ferrous malate powder.

### Example 11

An aqueous solution of malic acid is prepared by mixing 134.09 g of malic acid with 50 mL of water. An aqueous solution of calcium oxide is also prepared in a separate container by thoroughly mixing 56.08 g of calcium oxide in 50 mL of water. Next, 54.94 g of ferronyl powder is then added to the malic acid solution. The calcium oxide solution is then slowly added to the iron/malic acid solution. The solution is allowed to mix for approximately 2 hours. The resulting solution is then spray dried to produce a powdered dihydroxycalcium ferrous malate (or calciumhydroxy ferroushydroxy malate). The resulting product then is placed in a ultrasonification device. Upon placing the particles in an ultrasonification device and applying ultrasonification energy, the size of the particles are reduced to nanosized proportions.

As a modification to the process, rather than spray drying, upon forming the aqueous mixture of calcium oxide, iron and aqueous malic acid, the aqueous mixture is subjected to microwave hydrothermal energy. The resulting product is nanosized particles of dihydroxycalcium ferrous malate powder.

### Example 12

An aqueous solution of malic acid is prepared by mixing 134.09 g of malic acid with 50 mL of water. An aqueous solution of calcium hydroxide is also prepared in a separate container by thoroughly mixing 74.09 g of calcium hydroxide in 50 mL of water. Next, 54.94 g of ferronyl powder is added to the malic acid solution. The calcium hydroxide solution is then slowly added to the iron/malic acid solution. The solution is allowed to mix for approximately 2 hours. The resulting solution is then spray dried to produce a powdered dihydroxycalcium ferrous malate (or calciumhydroxy ferroushydroxy malate). The resulting product then is placed in an ultrasonification device. Upon placing the particles in the ultrasonification device and applying ultrasonification energy, the size of the particles are reduced to nanosized proportions.

As a modification to the process, rather than spray drying, upon forming the aqueous mixture of calcium hydroxide, iron and aqueous malic acid, the aqueous mixture is subjected to microwave hydrothermal energy. The resulting product is nanosized particles of dihydroxycalcium ferrous malate powder.

### Example 13

An aqueous solution of malic acid is prepared by mixing 134.09 g of malic acid with 50 mL of water. An aqueous solution of calcium carbonate is also prepared in a separate container by thoroughly mixing 100.09 g of calcium carbonate in 50 mL of water. Next, 54.94 g of ferronyl powder is added to the malic acid solution. The calcium carbonate solution is then slowly added to the iron/malic acid solution. The solution is allowed to mix for approximately 2 hours. The resulting solution is then spray dried to produce a powdered dihydroxycalcium ferrous malate (or calciumhydroxy ferroushydroxy malate). The resulting product then is placed in an ultrasonification device. Upon placing the particles in the ultrasonification device and applying ultrasonification energy, the size of the particles are reduced to nanosized proportions.

As a modification to the process, rather than spray drying, upon forming the aqueous mixture of calcium carbonate, iron and aqueous malic acid, the aqueous mixture is subjected to microwave hydrothermal energy. The resulting product is nanosized particles of dihydroxycalcium ferrous malate powder.

### Example 14

An aqueous solution of malic acid is prepared by mixing 134.09 g of malic acid with 50 mL of water. An aqueous solution of zinc oxide is also prepared in a separate container by thoroughly mixing 81.38 g of zinc oxide in 25 mL of water. An aqueous solution of calcium oxide is also prepared in a separate container by thoroughly mixing 56.08 g′ of calcium oxide in 25 mL of water. The zinc oxide solution and the calcium oxide solution are then slowly added to the malic acid solution. The resulting solution is then spray dried to produce a powdered dihydroxycalcium zinc malate (or calciumhydroxy zinchydroxy malate). The resulting product then is placed in an ultrasonification device. Upon placing the particles in the ultrasonification device and applying ultrasonification energy, the size of the particles are reduced to nanosized proportions.

As a modification to the process, rather than spray drying, upon forming the aqueous mixture of zinc oxide, iron and aqueous malic acid, the aqueous mixture is subjected to microwave hydrothermal energy. The resulting product is nanosized particles of dihydroxy zinc malate powder.

### Example 15

An aqueous solution of malic acid is prepared by mixing 134.09 g of malic acid with 50 mL of water. An aqueous solution of zinc oxide is also prepared in a separate container by thoroughly mixing 81.38 g of zinc oxide in 25 mL of water. An aqueous solution of calcium hydroxide is also prepared in a separate container by thoroughly mixing 74.09 g of calcium hydroxide in 25 mL of water. The zinc oxide solution and the calcium hydroxide solution are then slowly added to the malic acid solution. The resulting solution is then spray dried to produce a powdered dihydroxycalcium zinc malate (or calciumhydroxy zinchydroxy malate). The resulting product then is placed in an ultrasonification device. Upon placing the particles in the ultrasonification device and applying ultrasonification energy, the size of the particles are reduced to nanosized proportions.

As a modification to the process, rather than spray drying, upon forming the aqueous mixture of zinc oxide, calcium hydroxide and aqueous malic acid, the aqueous mixture is subjected to microwave hydrothermal energy. The resulting product is nanosized particles of dihydroxycalcium zinc malate powder.

### Example 16

An aqueous solution of malic acid is prepared by mixing 134.09 g of malic acid with 50 mL of water. An aqueous solution of zinc oxide is also prepared in a separate container by thoroughly mixing 81.38 g of zinc oxide in 25 mL of water. An aqueous solution of calcium carbonate is also prepared in a separate container by thoroughly mixing 100.09 g of calcium carbonate in 25 mL of water. The zinc oxide solution and the calcium carbonate solution are then slowly added to the malic acid solution. The resulting solution is then spray dried to produce a powdered dihydroxycalcium zinc malate (or calciumhydroxy zinchydroxy malate). The resulting product then is placed in an ultrasonification device. Upon placing the particles in the ultrasonification device and applying ultrasonification energy, the size of the particles are reduced to nanosized proportions.

As a modification to the process, rather than spray drying, upon forming the aqueous mixture of calcium carbonate, zinc and aqueous malic acid, the aqueous mixture is subjected to microwave hydrothermal energy. The resulting product is nanosized particles of dihydroxycalcium zinc malate powder.

### Example 17

A dicalciumhydroxy malate granular product is prepared by mixing two molar equivalents of particulate calcium hydroxide with one molar equivalent of particulate malic acid (totaling 45 kg for the entire composition) in a Ribbon Blender for 15 minutes at normal speeds. A water jacket is used to ensure that the product does not over react when small amounts of water were added to the batch. Next, about 1 L of water is slowly sprayed into the particulate mixture product. After about 10 minutes of reaction time (where the product becomes spongy and rises, and then dropped back to a more granular state), an additional 1 L of water is added. This is repeated several times until no further reaction appears to be occurring upon addition of water. The end result is a granular product. Once a fully reacted granular product is formed, no additional water is added. The resulting granular product then is placed in an ultrasonification device. Upon placing the particles in the ultrasonification device and applying ultrasonification energy, the size of the particles are reduced to nanosized proportions.

As a modification to the process, calcium hydroxide and malic acid are combined to form an aqueous mixtures and the aqueous mixture subjected to microwave hydrothermal energy. The resulting product is nanosized particles of dihydroxycalcium malate powder.

### Example 18

The same process of Example 17 is followed, except that magnesium hydroxide is used instead of calcium hydroxide. This process results in a granular dimagnesiumhydroxy malate that may be subjected to ultrasonification to create a product of nanosized proportions or reacted in aqueous conditions with application of microwave hydrothermal energy to form a nanosized product.

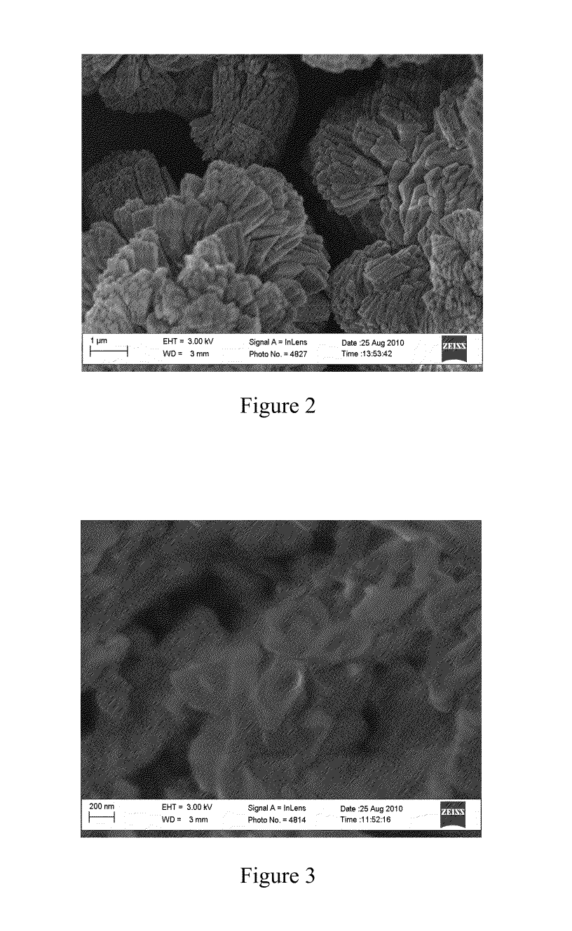

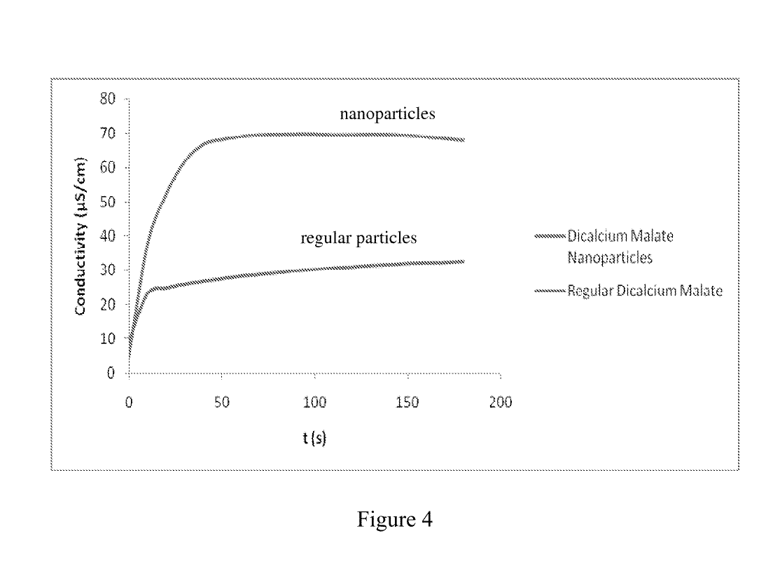

FIGS. 2 and 3 are scanning electron micrographs of regularly sized and nanosized dihydroxycalcium malate, respectively. FIG. 2 shows the regularly sized dihydroxycalcium malate particles. The scale indicator on FIG. 2 indicates one micron. The regularly sized particles are greater than at least 10 microns.

FIG. 3 has a scale indicator of 200 nanometers. The nanosized particles in FIG. 3 are made according to one method of the invention described herein and have a diameter of approximately 200 nanometers. The decrease in particle size provides an increase in surface area which will be expected to increase the dissolution rate of the particles.

Dihydroxycalcium malate particles were made in micron and nanosized proportions and subjected to evaluation. As illustrated in FIG. 4, particles of regular size and nanosized proportion were subjected to dissolution testing. FIG. 4 shows the conductivity measured in a solution in which the particles have been placed. Table 1 provides the data measured and reported in FIG. 4. The nanosized particles dissolve more rapidly compared to the regular sized dihydroxycalcium malate particles. The measure of conductivity indicates that the nanosized particles also disassociate more completely, thereby freeing the calcium and making it available for absorption in the gastrointestinal tract. Therefore, the nanosized particles formulated in a calcium dosage form will be expected to dissolve more quickly, disassociate more quickly and be absorbed in the human body more quickly and completely.

TABLE 1
Conductivity data for dihydroxycalcium malate particles

| | Regular sized | Nano sized |
|---|---|---|
| Time | Conductivity | Conductivity |
| (seconds) | (μS/cm) | (μS/cm) |
| 0 | 9.32 | 5 |
| 10 | 23.2 | 37.5 |
| 20 | 24.9 | 52.2 |
| 30 | 26 | 61.8 |
| 40 | | 66.8 |
| 50 | 27.6 | 68.2 |
| 60 | 28.3 | 69.1 |
| 70 | 28.8 | 69.6 |
| 80 | 29.3 | 69.8 |
| 90 | 29.9 | 69.9 |
| 100 | 30.3 | 69.9 |
| 110 | 30.7 | 69.6 |
| 120 | 31 | 69.6 |
| 130 | 31.4 | 69.8 |
| 140 | 31.7 | 69.7 |
| 150 | 32 | 69.4 |
| 160 | 32.2 | 69 |
| 170 | 32.3 | 68.5 |
| 180 | 32.6 | 68 |

The inventors also have determined that there may be a utility in forming nanoparticles of a therapeutic agent, such as calcium, in a composite or adduct with a pharmaceutical excipient such as titanium oxide or silicon dioxide. To determine the ability to product such a composite or adduct (i.e., a mixture in which there is weak bonding between the components), the inventors reacted succinic acid with aqueous urea followed by addition of calcium nitrate and titanium oxide using conditions similar or the same as those discussed above (Method A). In another reaction, the inventors neutralized succinic acid in aqueous calcium carbonate followed by the addition of titanium oxide (Method B). Following these reactions, the following analytical tools were used to quantify the presence of calcium succinate on the titanium oxide: ICP-MS, FTIR, TGA, NMR, and XRD.

The data of Table 2 shows that when the calcium succinate was formed with titanium dioxide as described above the amount of calcium succinate in a complex with the titanium dioxide is approximately the theoretical amount using ICP-MS analysis.

TABLE 2
ICP-MS results for calcium succinate with titanium

| | | | | Average | |
|---|---|---|---|---|---|
| | Average | Average | | total | |
| | Sample | total Ca | Theo- | titanium | Theo- |
| Calcium | mass | by mass | retical | by mass | retical |
| succinate—TiO₂ | (mg) | (mg) | Calcium | (mg) | titanium |
| Method A | 105.4 | 11.73 | 16.95 mg | 20.98 | 20.29 mg |
| | | | Ca/100 mg | | Ti/100 mg |
| | | | sample | | sample |
| Method B | 102.1 | 16.21 | 16.95 mg | 20.32 | 20.29 mg |
| | | | Ca/100 mg | | Ti/100 mg |
| | | | sample | | sample |

The data of Table 2 shows that the reaction sequence of Method B results in a greater weight percentage of the calcium being in the adduct in comparison to the reaction sequence of Method A.

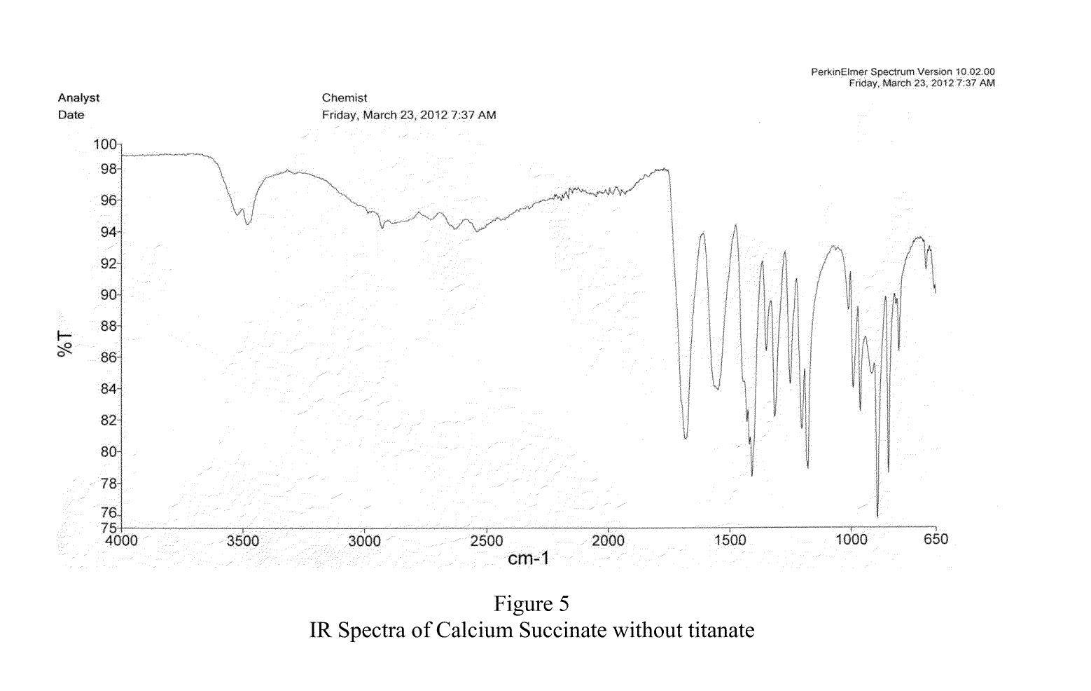

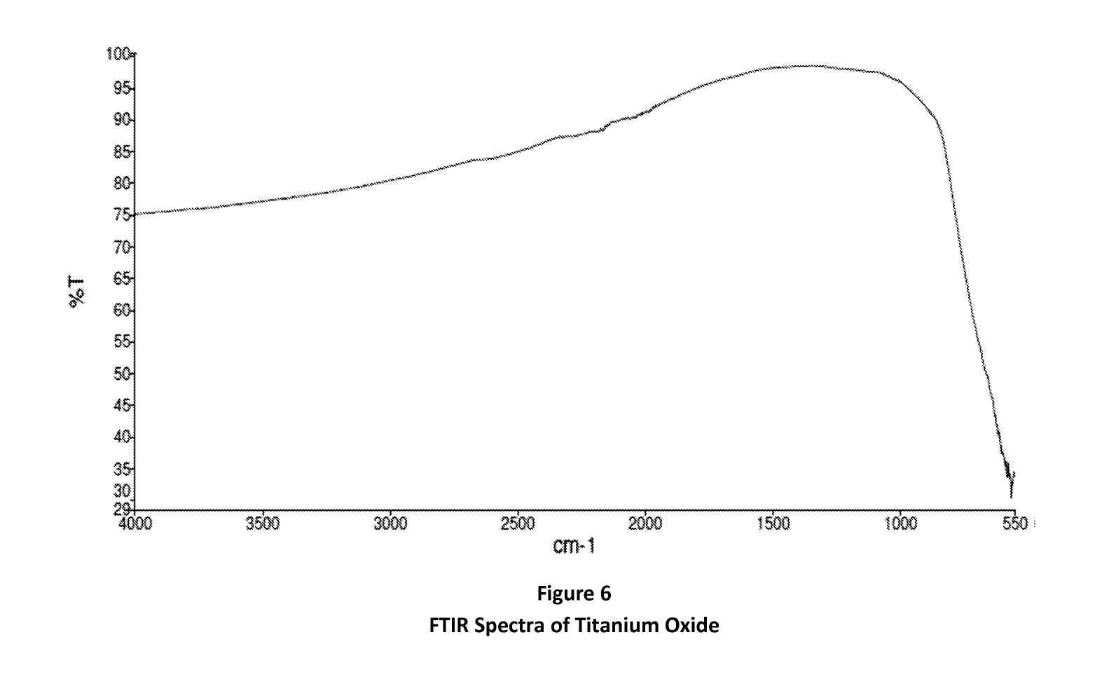

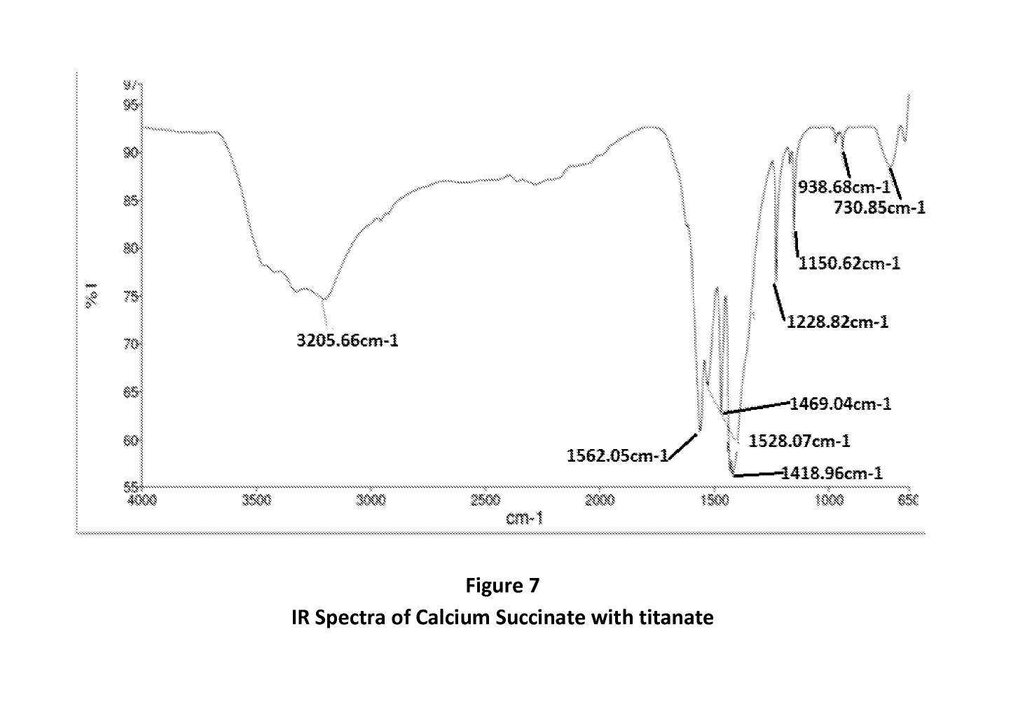

The data of FIGS. 5-7 are FTIR spectra of calcium succinate, titanium oxide, and calcium succinate with titanium oxide (titanate), respectively. These figures show that when the calcium succinate was formed with titanium oxide as described above the amount of calcium succinate in the adduct with the titanium oxide is forming a bond that is more than a mere mixture of the two compounds.

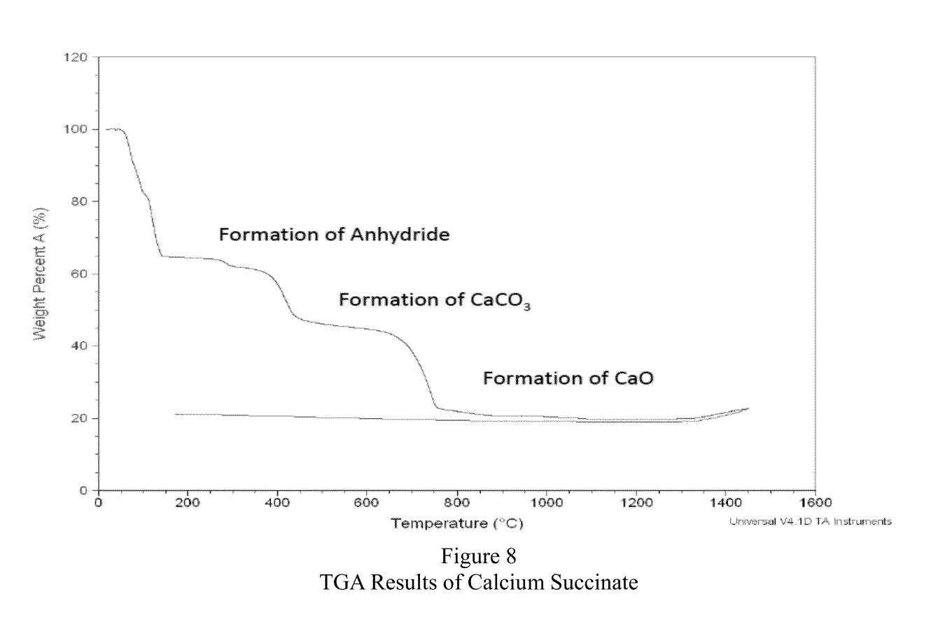

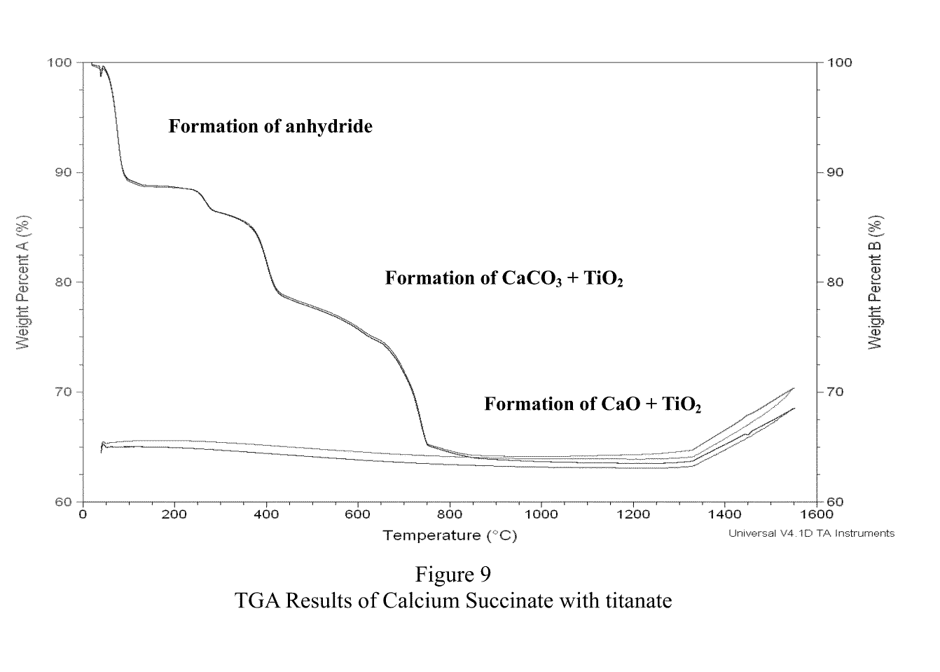

FIGS. 8-9 are graphs showing the TGA results for calcium succinate (FIG. 8) and calcium succinate with titanate (FIG. 9). The graphs have been annotated to show the decomposition of the compound. In FIG. 8, the results of a single sample is reported. In FIG. 9, the results of two samples are reported. The left axis is sample A and the right axis is sample B. In the results, the upper line represents sample A results and the lower line represents sample B results. The results showing decomposition generally are superimposed on each other, as would be expected. These graphs are used to verify the understanding that the calcium succinate and titanium oxide are present in the formed product.

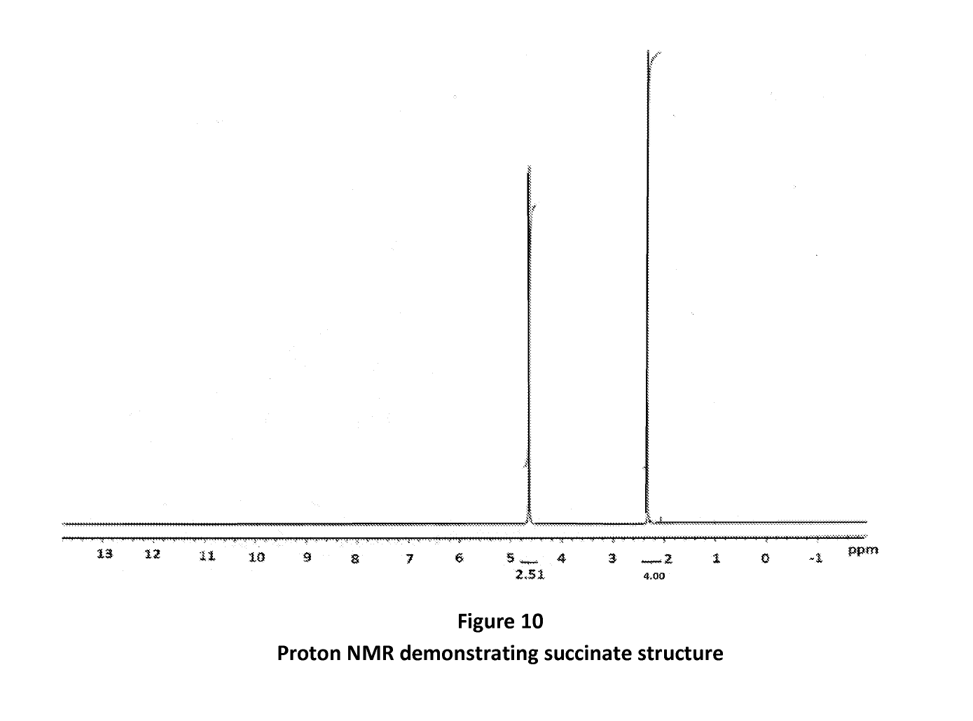

FIG. 10 is a proton NMR which verifies the structure of the succinate group and demonstrates that the method of forming calcium succinate in the process results in a calcium succinate of high purity.

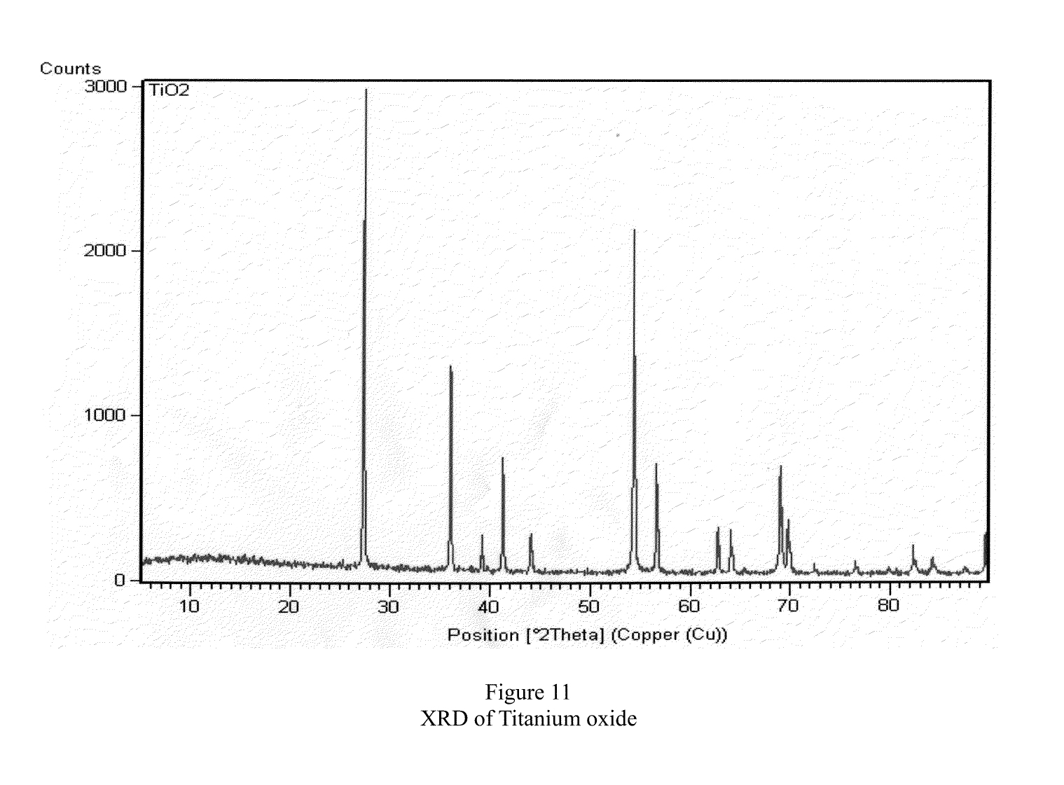

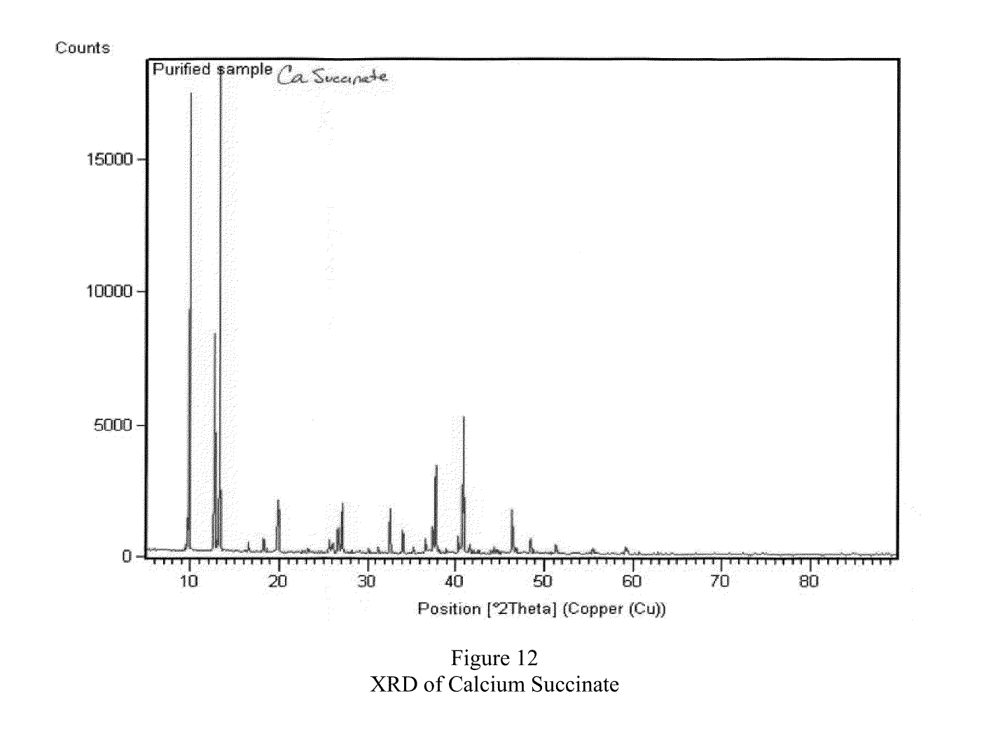

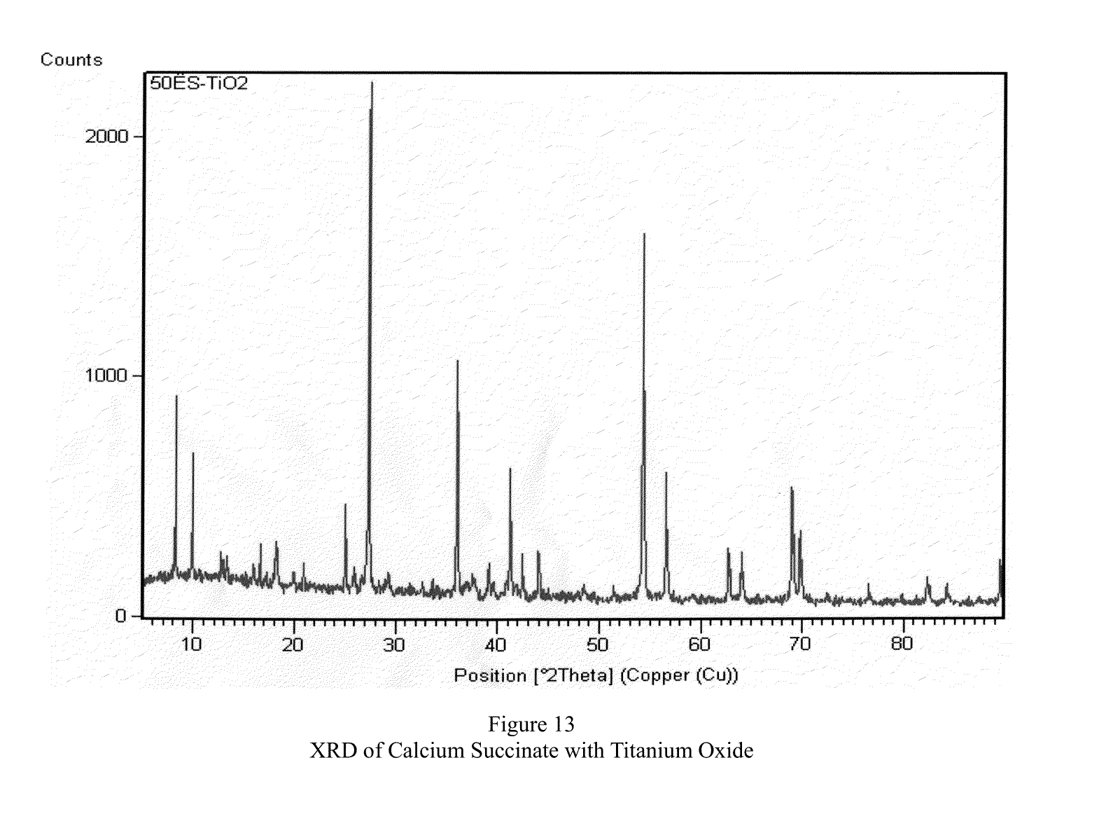

FIGS. 11-13 are XRD patterns of titanium oxide individually, calcium succinate individually, and calcium succinate with titanium oxide (titanate). These results demonstrate that both compounds are present together after the synthesis is complete. This supports the understanding above that the mixture of the two compounds is in the form of an adduct.

The nanosized calcium or other mineral or metal compounds disclosed herein can be used in a pharmaceutical or nutraceutical composition to increase the intake of calcium or other mineral or metal in an individual in need thereof.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. A composition in particle form having the structure: 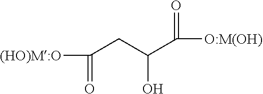
wherein M and M′ are each independently a nutritionally relevant divalent metal and the particles are of a size between 1 micron and 1 nanometer.

2. A composition of claim 1, wherein M is one or more of calcium, magnesium, zinc, copper, iron, manganese.

3. A composition of claim 1, wherein M and M′ are the same nutritionally relevant divalent metal selected from the group consisting of copper, zinc, manganese, iron, magnesium, and calcium.

4. A composition of claim 1, wherein M and M′ are different nutritionally relevant divalent metals, each being selected from the group consisting of copper, zinc, manganese, iron, magnesium, and calcium.

5. The composition of claim 1, wherein the particles are made according to a process that includes application of microwave hydrothermal energy.

6. The composition of claim 5, wherein the application of microwave hydrothermal energy occurs during synthesis of the compound.

7. The composition of claim 6, wherein the product resulting from the synthesis is subjected to ultrasonification to reduce the particle size.

8. The composition of claim 1, wherein the particles are made according to a process that includes ultrasonification.

9. The composition of claim 1, further comprising one or more pharmaceutically acceptable excipients.

10. A method of improving the nutritional status of a warm-blooded animal, the method comprising administering the composition of claim 1.

11. The method according to claim 9, wherein M and M′ are the same or different nutritionally relevant divalent metal selected from the group consisting of copper, zinc, manganese, iron, magnesium, and calcium.

12. The method of claim 9, further comprising the preliminary step of formulating the composition into a tablet or capsule for oral delivery.

13. The method of claim 13, further comprising the preliminary step of formulating the composition into a food or beverage for oral delivery.

14. A process for making a bioavailable divalent metal-containing complex in nanosized particle form of the following formula 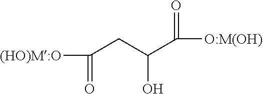
the method comprising:
adding malic acid and one or more divalent metal-containing compositions to a reaction vessel, wherein M and M′ are each independently a nutritionally relevant divalent metal selected from calcium, magnesium, zinc, copper, iron, and manganese;
reacting the malic acid with the one or more divalent metal-containing composition; and
applying microwave hydrothermal energy to the reaction vessel and contents, wherein the resulting particles have a size between one micrometer and one nanometer.

15. The process according to claim 14, wherein M and M′ are the same nutritionally relevant divalent metal selected from the group consisting of copper, zinc, manganese, iron, magnesium, and calcium.

16. The process according to claim 14, wherein M and M′ are different nutritionally relevant divalent metals, each being selected from the group consisting of copper, zinc, manganese, iron, magnesium, and calcium.

17. The process according to claim 14, further comprising application of ultrasonification to the particles to reduce the particle size.

18. The process according to claim 14, wherein the nanosized particles are formulated into a formulation.

19. A process of making a bioavailable divalent metal-containing complex in nanosized particle form of the following formula 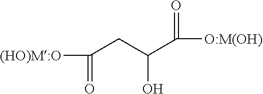
the method comprising:
adding malic acid and one or more divalent metal-containing compositions to a reaction vessel, wherein M and M′ are each independently a nutritionally relevant divalent metal selected from calcium, magnesium, zinc, copper, iron, and manganese;
reacting the malic acid with the one or more divalent metal-containing composition; and
applying ultrasonification to the resulting composition, wherein the resulting particles have a size between one micrometer and one nanometer.

20. The process according to claim 19, wherein M and M′ are the same or different nutritionally relevant divalent metals, each being selected from the group consisting of copper, zinc, manganese, iron, magnesium, and calcium.
